(19) United States
(12) Patent Application Publication
(10) Pub. No.: US 2002/0100042 A1
(43) Pub. Date: Jul. 25, 2002

(54) Method and system for providing intelligent advertisement placement in a motion picture

(76) Inventors: Denis Khoo, Los Angeles, CA (US); Raymond F. Ratcliff III, Plano, TX (US)

Correspondence Address: PILLSBURY WINTHROP, LLP, P.O. BOX 10500, MCLEAN, VA, 22102, US

(21) Appl. No.: 10/112,519

(22) Filed: Mar. 29, 2002

Related U.S. Application Data
(63) Continuation-in-part of application No. 09/487,120, filed on Jan. 19, 2000.

(51) Int. Cl. H04N 7/025; H04N 7/10; G06F 3/00; H04N 5/445; G06F 13/00

(52) U.S. Cl. 725/34; 725/35; 725/42

(57) ABSTRACT

The present invention provides a method and system for intelligently embedding advertisements into motion picture content. An embodiment of the method includes receiving personalized data and the identity of a motion picture from a user over a computer network; selecting an advertisement image having attributes that approximately match the personalized data; editing the motion picture to include the selected advertisement image; and transmitting the edited motion picture to the user over the computer network for viewing. An embodiment of the system includes a computer system for performing the above-described method.

### RELATED APPLICATIONS

This application is a continuation-in-part of an application entitled “Method and System for Providing a Customized Media List,” filed Mar. 4, 2002, which is a continuation of U.S. patent application No. 09/487,120, filed Jan. 19, 2000.

### FIELD OF THE INVENTION

The present invention relates generally to providing advertisements in a motion picture video. More particularly, the present invention relates to providing personalized advertisements in the motion picture video to different viewers of the video.

### BACKGROUND OF THE RELATED ART

Conventional broadcast media (including visual and audio media over a television) has been provided to viewers and listeners for decades and typically falls under the paradigm illustrated in prior art FIG. 1. Prior art FIG. 1 is a block diagram view of a conventional broadcast media paradigm. In prior art FIG. 1, media 5, includes both content 10 (e.g. television shows, sports, news, weather, movies, concerts, etc.) and advertising 15. The content 10 is provided to the viewer and listener for entertainment or information purposes, while the advertising 15 is typically used to provide revenues for the broadcaster 20. Advertisements 15 are conventionally full-screen on the television and interrupt the content 10 being shown. There are typically a few advertisements 15 shown back-to-back. The content 10 continues where it left off after the advertisements 15 are complete. The broadcaster 20 shares the advertising revenues with the content 10 providers. Thus, from FIG. 1, the broadcaster 20 is the distributor 25 of the content 10 and the advertising 15 to the viewer 30 through a distribution means 35. The distribution means 35 includes public broadcast 40, cable 45 distribution and satellite 50 distribution. In essence, the broadcaster 20 distributes the content 10 and advertising 15 through the distribution means 35 and generally shares the costs of distributing such content 10 and advertising 15 with the viewer 30 through the distribution means 35. The viewer 30 might have a hardware device that allows for the digital recording of distributed media 5. Such device attaches between the distribution means 35 and the television 55. A common term for such a device is a Personal Video Recorder (PVR). A PVR allows the viewer 30 to easily record and replay the distribute media 5. The digital nature of this device makes it possible for the viewer 30 to quickly access, fast-forward, rewind, pause, etc. the distributed media 5.

Several disadvantages exist with the paradigm of prior art FIG. 1. These disadvantages are shared by the advertisers of the advertising 15, the broadcasters 20 and the viewer 30. A first disadvantage is that all viewers 30 watching the same channel see the same advertising 15. Since advertisers can only guess as to the target audiences viewing the content, the advertisers are paying for advertising that may never reach the full target audience. A second disadvantage is that viewers 30 are inconvenienced with advertising 15 interruptions. A viewer may spend 30 minutes to watch a content 10 that is only 22 minutes long. This is because the viewer 30 must wait for advertising 15 to be completed before the viewer can continue watching the content.

A third and recent disadvantage is that broadcasters may lose revenues if viewers 30 start using PVR systems to skip over the advertising 15. This will have a major impact on the broadcaster and the content provider, since nearly all of the revenues are a result of the advertising 15.

FIG. 2 shows a conventional system for delivering embedded advertisements in a motion picture to a number of different viewers. This system of delivering embedded advertisement is also known as product placement. Some movies and television programs currently include product placements. A product placement is a gratuitous placement of a particular product in a scene of the movie or television program intended to be seen by the viewer. Product placements serve as advertisements embedded within content.

There are countless examples of product placements. One example is a movie in which a bank robbery is about to take place. The scene shows several cars driving on the street, and one of a plain white delivery truck with no logo driving by. An example of product placement would be if a “Fed-Ex” logo were graphically added onto the side of the truck. Viewers watching the movie would now see a “Fed-Ex” truck driving across the screen. Another example is a reality-based television program in which participants open a treasure chest which has a “Target” logo emblazoned on the outside of the chest.

In FIG. 2, a single source of motion picture content 210 includes a product placement as an advertisement. The product placement is an image of an advertisement for the product that is embedded in the motion picture content. The motion picture content 210 is distributed to a number of different viewers, in particular, viewer A 220, viewer B 230, viewer C 240, and viewer D 250. The viewers in FIG. 2 may be situated in various locations, as will be understood by the skilled artisan. For example, viewer A may be watching a television in a house in California. Viewer B may represent a family of viewers watching a television in Indiania. Viewer C may represent one or more viewers of the motion picture content over a satellite transmission network in China. Because the product placement is embedded in the motion picture content 210, the advertisement is delivered to the various viewers using a “shotgun” approach to the distribution. There is no doubt that a number of people watching the motion picture content will be the ideal target for the advertiser of the product. However, the advertisement is most likely inaccurately delivered to a number of other viewers. For example, the company target may only want to advertise to a certain segment of the viewers of a particular television program. Another advertiser, like Nordstroms, may wish to reach another group of viewers watching the same television program. With conventional methods, however, there is no way to individualize the advertising to the respective viewers shown in FIG. 2,

### SUMMARY OF THE INVENTION

The present invention provides a method for intelligently embedding advertisement into motion picture content. The method includes the step of providing personalized data of the user to a computer system. Then, identifying a region within a motion picture where an advertisement image will be imposed. The advertisement image is selected from a database of advertisement images. The selection of the proper advertisement image to impose is selected by considering the personalized data of the user. The advertisement image is imposed onto the motion picture, and then delivered to the user for viewing. The user, based on personalized data provided by the user, while watching the motion picture, will see advertisements embedded within the motion picture, that has been targeted to the user.

### BRIEF DESCRIPTION OF THE FIGURES

A more complete appreciation of the invention and many of the advantages thereof will be readily obtained as the same becomes better understood by reference to the detailed description when considered in connection with the accompanying drawings, wherein:

FIG. 1 is a prior art block diagram view of a broadcast media industry paradigm;

FIG. 2 is a prior art block diagram example of the distribution of product placement enabled content;

FIG. 3 is a block diagram example of targeting content with a variation of product placements to individuals;

FIG. 4a and FIG. 4b are snapshots of the same motion picture content with differing product placements;

FIG. 5 is a block diagram view of an embodiment of the computer system of the present invention;

FIG. 6 is a block diagram view of an embodiment of the server of the present invention;

FIG. 7 is a block diagram view of an embodiment of the data storage for the advertisement images of the present invention;

FIG. 8 is a block diagram view of an embodiment of the computer system of the present invention;

FIG. 9 is a block diagram view of an embodiment of the server of the present invention;

FIG. 10 is a flow chart of an embodiment of the method of the present invention;

FIG. 11 is a flow chart of an embodiment of the targeted product placement method of the present invention;

FIG. 12 is a flow chart of an embodiment of the targeted product placement method of the present invention; and

FIG. 13 is a block diagram view of a general purpose computer that may be used to implement an embodiment of the method and system of the present invention.

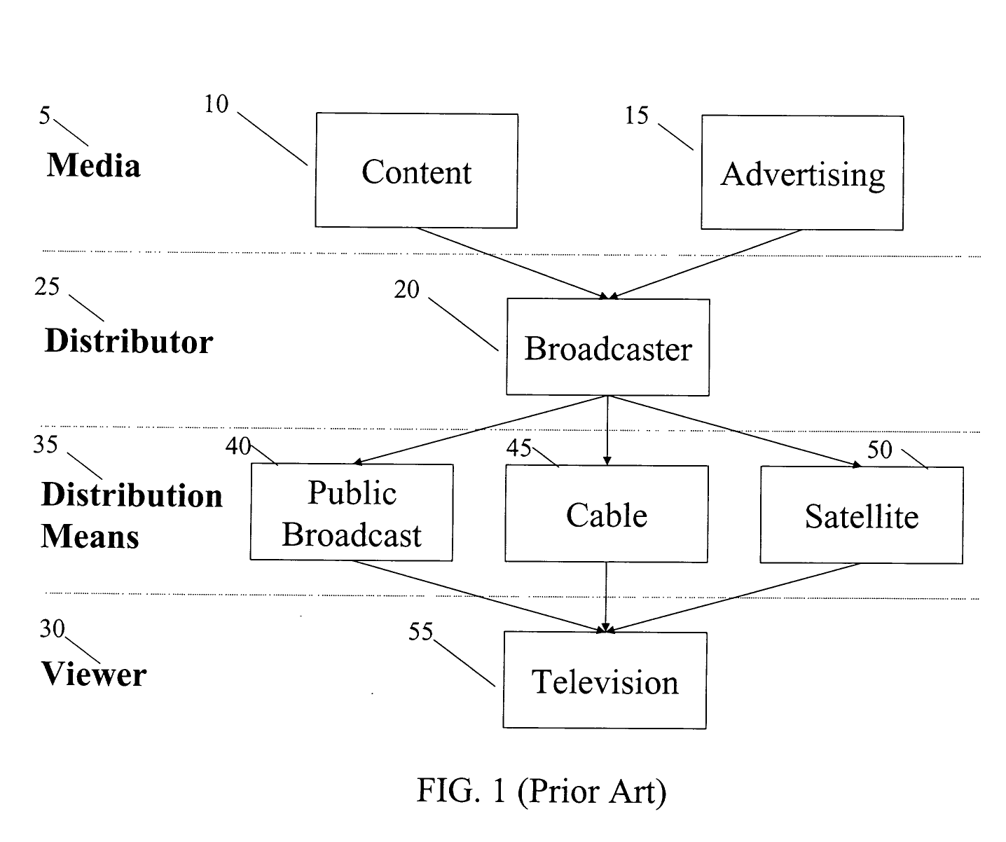

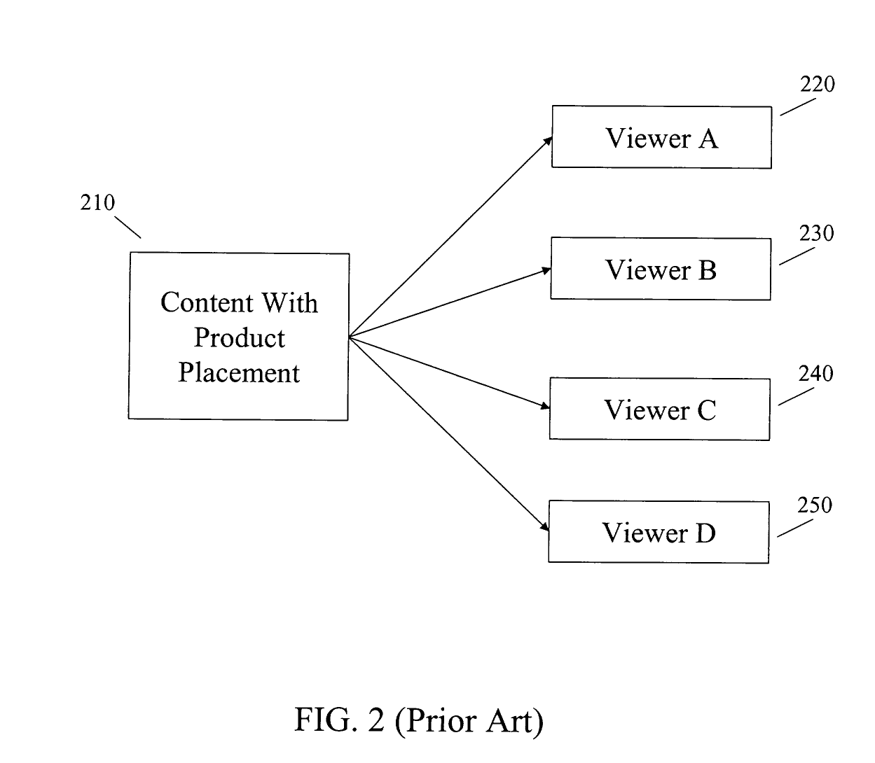

### DETAILED DESCRIPTION OF PREFERRED EMBODIMENTS

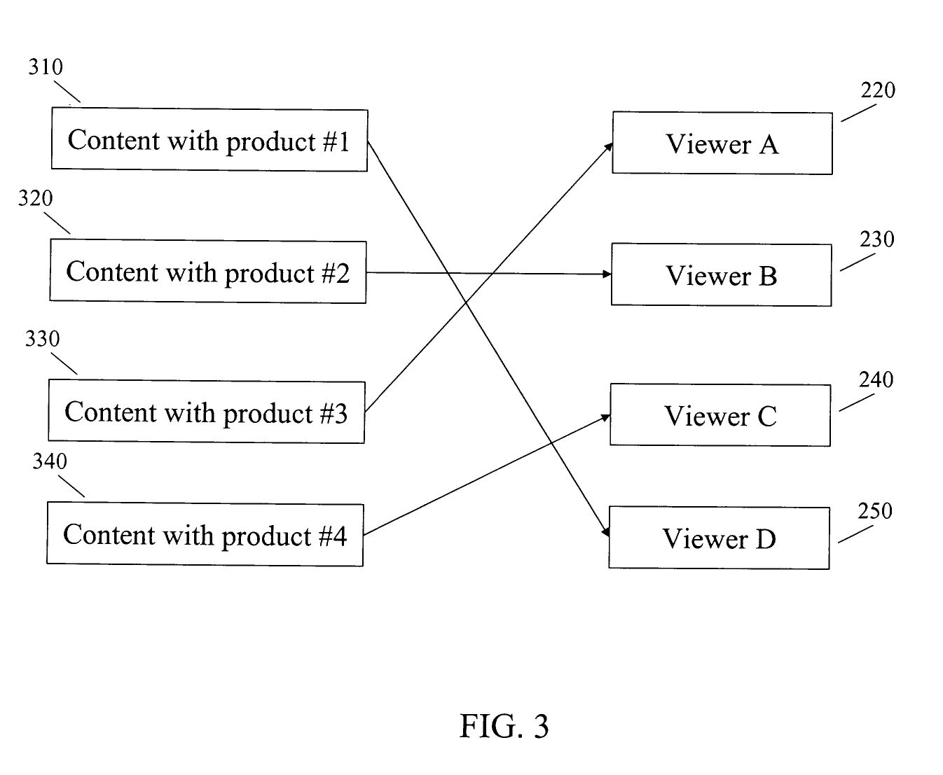

FIG. 3 is a block diagram showing the delivery of motion picture content with personalized advertisements to a plurality of viewers, practiced in accordance with an exemplary embodiment of the present invention. In FIG. 3, a plurality of versions of the motion picture content are provided. Each version includes a respective advertisement image of a different product embedded in the motion picture content. One version of the content 310 includes an embedded image of product number 1. A second version of the motion picture content 320 includes an image of product number 2 embedded in a portion of the motion picture content corresponding to the portion in which product number 1 is embedded in the first version, etc. In accordance with exemplary embodiments of the present invention, each version of the motion picture content is delivered to one or more viewers based on personalized data associated with each of the one or more viewers. This personalized data is often demographics information and can include information such as age, gender, income level, occupational, recreational interests, and geographic locations. Other types of personalized data may be incorporated as will be understood by the skilled artisan. Using the systems and methodologies described below, selection of a particular version of the motion picture content for delivery to a particular viewer will depend on that viewers personalized data. The version of the motion picture having an advertisement image most relevant to that viewer based on the viewers personalized data is delivered. Using exemplary embodiments of the present invention, the model shown in FIG. 3 can be followed to reach and unlimited number of potential viewers to deliver the most relevant advertisements provided by thousands of potential advertisers, using the various demographics provided by viewers of a motion picture. For the purpose of this invention, the term “motion picture” should be interpreted broadly to include any type of video such as television programs and movies.

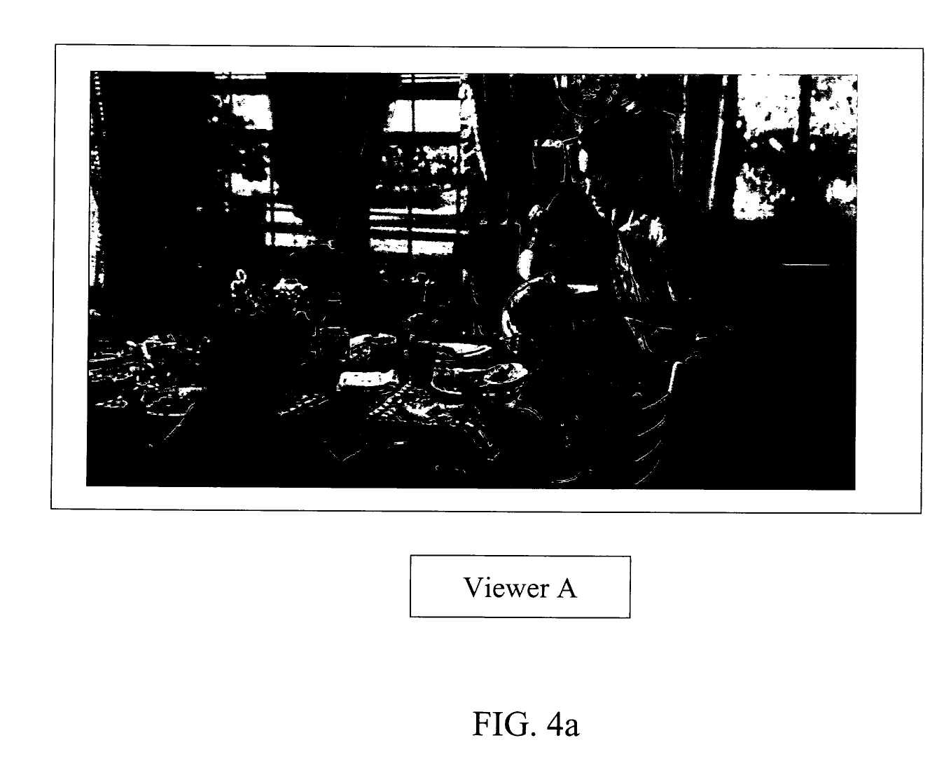

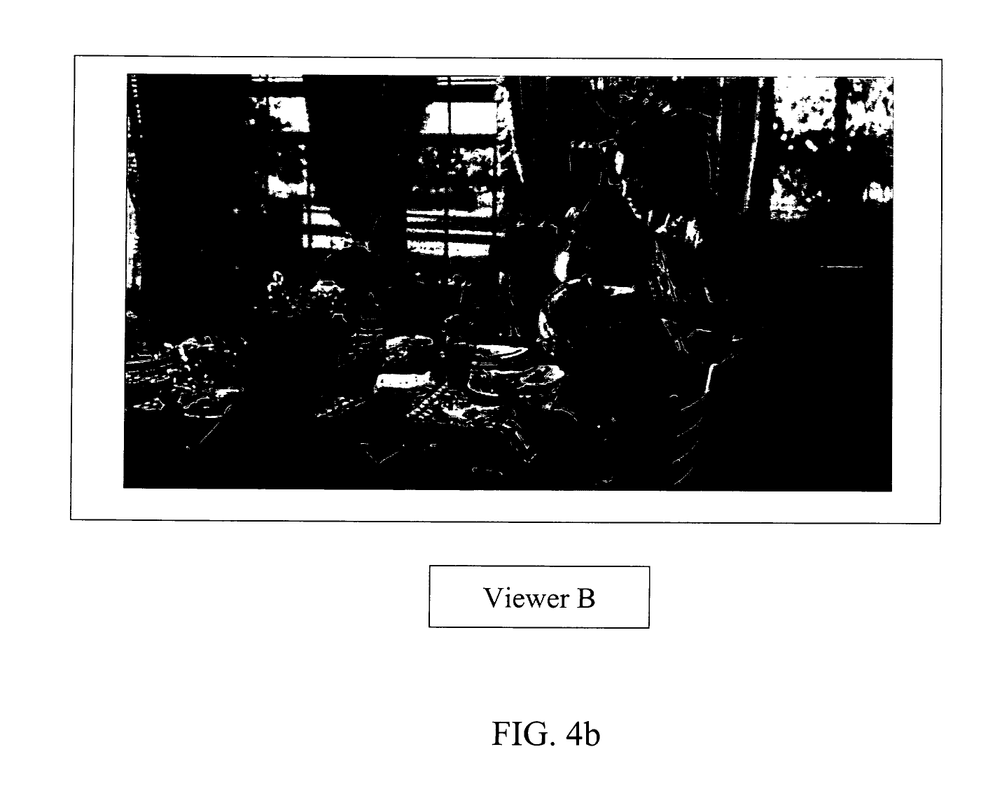

FIG. 4A is a block diagram showing the presentation of a personalize version of motion picture content on a display device for viewing by a particular viewer based on that viewer's personalized data, in accordance with an exemplary embodiment of the present invention. FIG. 4B shows a different version of the same motion picture content provided to a different viewer based on that viewer's personalized data. In FIG. 4A, using the system and methodology described below, it is determined that viewer A's demographic information suggests an interest in Heinz's 57 steak sauce as a topping for a sandwich. Alternatively, the demographics information associated with viewer B suggests a preference for French's mustard as opposed to Heinz's steak sauce. Thus, in accordance with exemplary embodiments of the present invention, the versions of the motion picture content most suitable to the respective viewers are delivered as shown in FIGS. 4A and 4B.

FIGS. 4A and 4B show the functionality of embodiments of the present invention in delivering different products to different viewers watching the same movie or television program, for instance. Exemplary embodiments of the present invention allow artists to “doctor” a piece of motion picture content and change the way items appear in that piece of content.

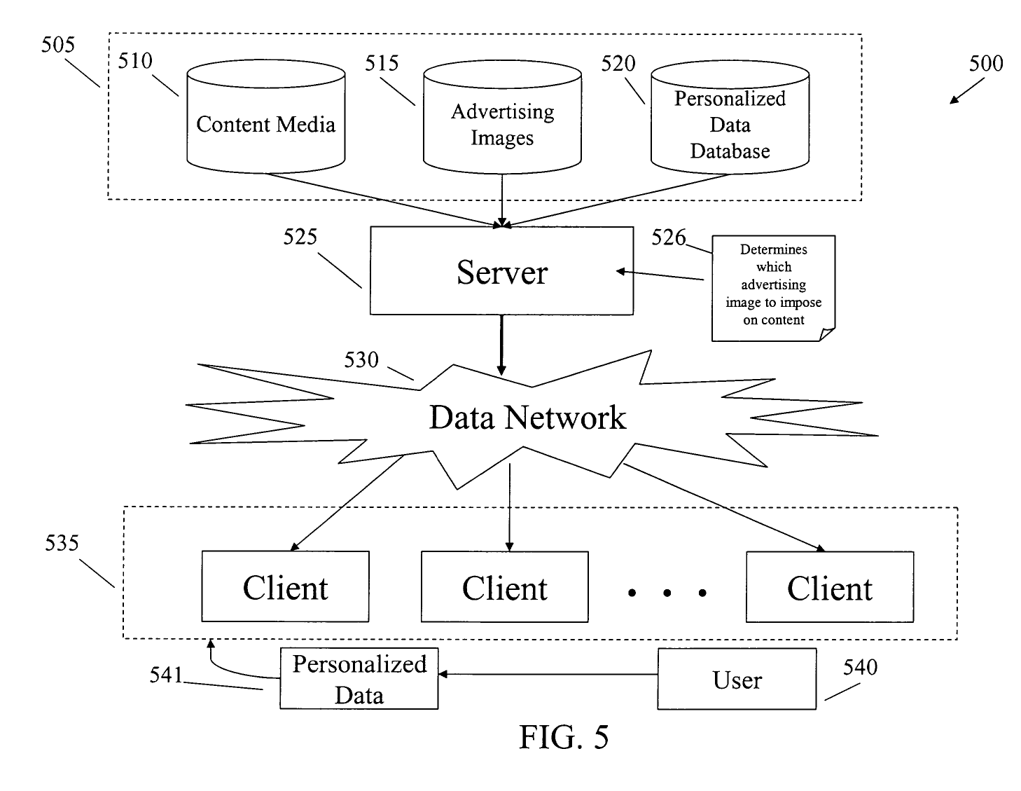

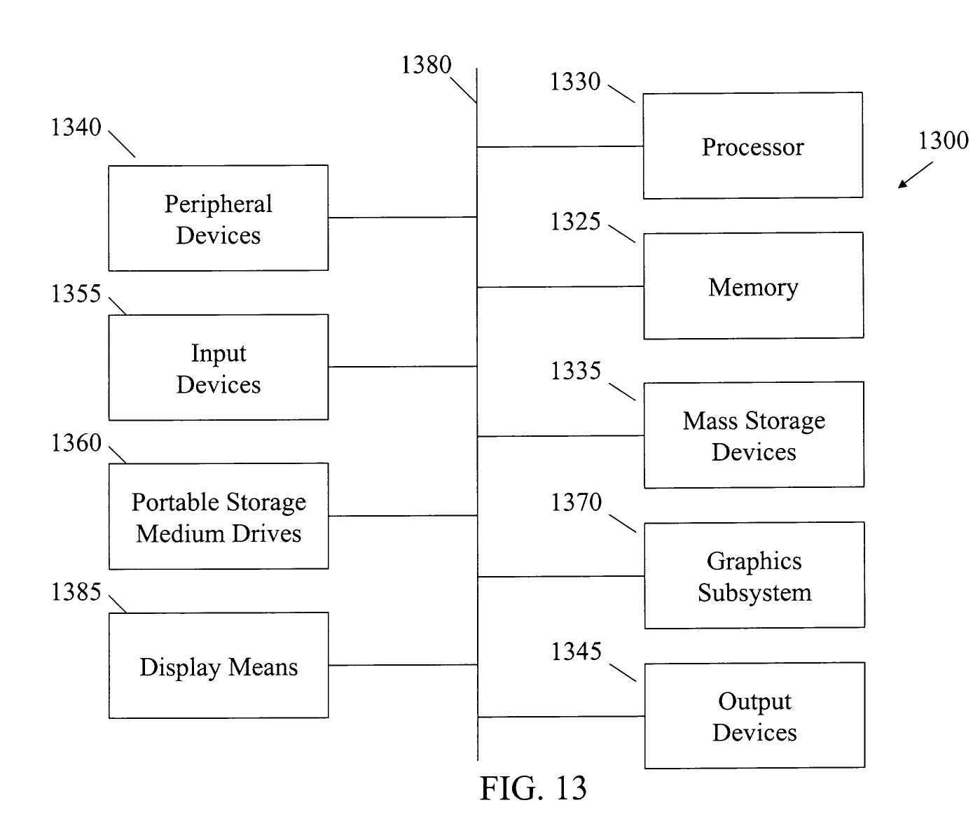

FIG. 5 is a block diagram showing an exemplary system for delivering a motion picture having a personalize advertisement to a viewer, in accordance with an exemplary embodiment of the present invention. In FIG. 5, the system 500 of FIG. 5 includes a plurality of clients 535 in communication with a server 525 through a data network 530. The clients 535 represent, in one example, set top boxes or control boxes connected to television sets viewed by respective users associated with the clients. In another example, the clients present computers or other data processing apparatus such as the apparatus illustrated or described in FIG. 13 further below.

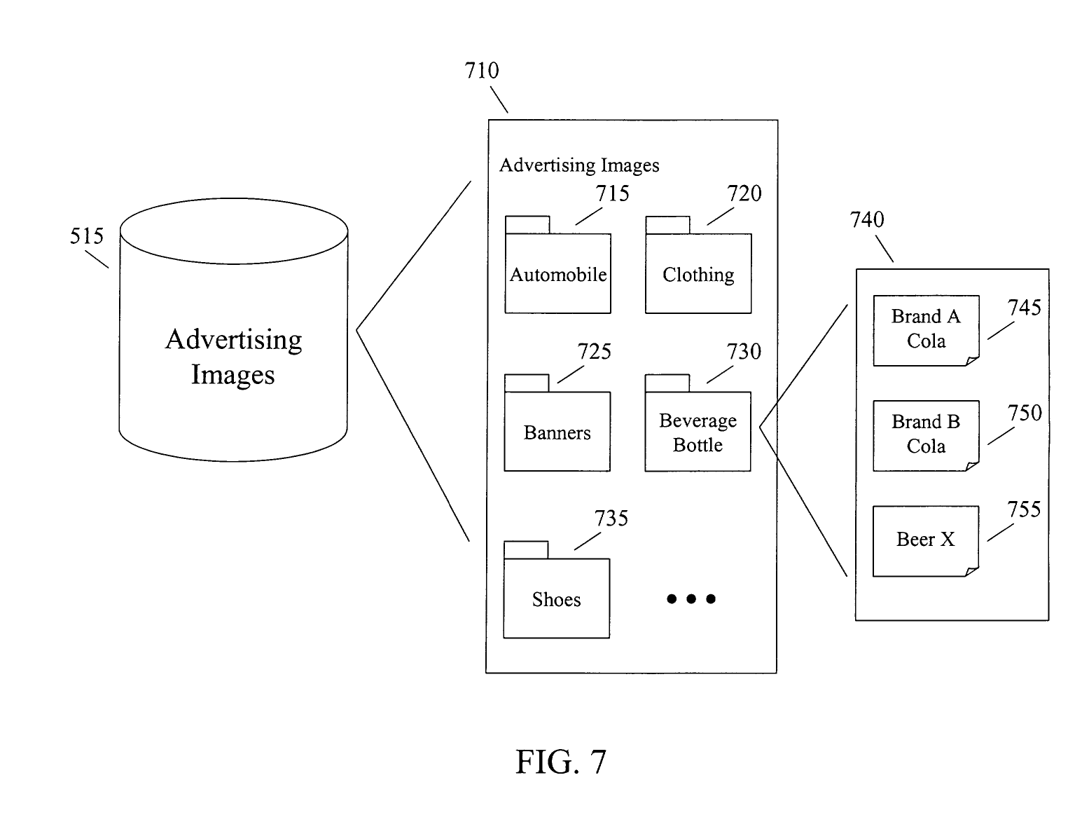

The server 525 is in communication with a data storage facility 505 in which data used by the server 525 is provided. Data storage facility 505 includes content media or other motion picture content stored in a storage medium 510, advertisement images stored in the same or a different storage medium 515, and personalized data stored in a database 520 or other suitable storage medium. The content media 510 generally includes one or more motion pictures stored as video signals on the storage medium. These motion pictures are provided to server 525 upon request by the server. The advertisement images 515 include a plurality of image files, generally arranged in a hierarchical format as shown in FIG. 7, which can be retrieved and imposed on the retrieved motion picture content by server 525 for delivery of the personalized advertisement to the viewer. The selection of the particular advertisement image 515 depends on the personalized data 520 associated with a particular viewer, as described in greater detail below. The server 525 imposes a particular advertisement image on a sequence of image frames comprising the retrieved motion picture content. The processed motion picture can then be delivered to one or more particular clients 535 based on the personalized data associated with those clients. This process is described in greater detail below. In FIG. 5, a viewer or user 540 provides personalized data 541 to the server 525 through a particular client 535. This personalized data is stored in database 520 and indexed by the user's name or other suitable identification for later retrieval. When the user requests motion picture content through a particular client 535, the personalized data previously submitted by that user is retrieved by server 525 from database 520 and used to determine the most appropriate advertisement image from storage medium 515 to impose on the motion picture content from storage medium 510.

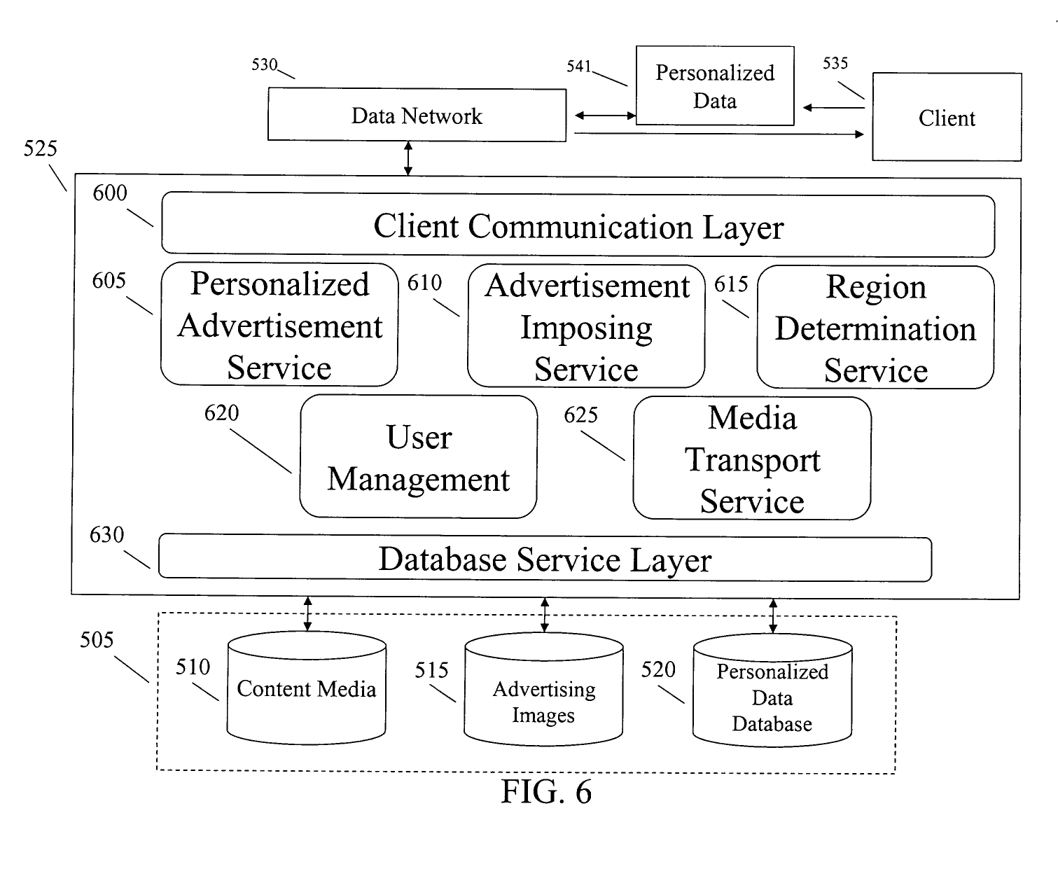

FIG. 6 shows server 525 of FIG. 5 constructed according to an exemplary embodiment of the present invention. The server 525 includes a client communications layer which serves as an interface to the clients 535. This client communications layer 600 is a robust interface in that it enables communications between the server and any number of devices used as the client, such as those described above. The server 525 further includes a database service layer 630 which also serves as an interface with the data storage facility 505. The database service layer 630 enables communications between the server 525 and the various databases and other storage media used as repositories for the respective types of data in data storage facility 505, including content media 510, advertisement images 515, and the personalized data database 520. The database service layer 630 serves as a channel through which the various data in storage facility 505 are retrieved by the server 525 for delivery to clients 535.

In FIG. 6, the server 525 includes a user management module 620 which functions to collect personalized data 541 submitted by the client 535 for a particular viewer through data network 530. The user management module 620, upon receiving the personalized data 541, sends the data 541 to the personalized data database 520 through the database service layer 630 for storage and later retrieval.

In FIG. 6, the server 525 further includes a region determination service module 615. When a television program or other motion picture is retrieved from content media storage medium 510, the region determination module 615 identifies a region within each of a sequence of image frames comprising the motion picture for editing. The server 525 further includes an advertisement imposing service module 610 in communication with the region determination module 615. The advertisement imposing service module 610 is an engine which imposes an advertisement image on a retrieved motion picture. In particular, the advertisement imposing service module 610 gathers information from region determination service module 615, where such information identifies a region for imposing of an advertisement image. After it determines which of a plurality of advertisement images is most suitable to be imposed on the region in a sequence of image frames, described in greater detail below, the advertisement imposing service module 610 imposes the selected advertisement image on a region within a sequence of image frames comprising the motion picture.

In FIG. 6, the personalize advertisement service module 605 provides a matching service. That is, the personalized advertisement service module 605 determines which advertisement is most suitable for a particular viewer. The personalized advertisement service module 605 retrieves personalized data for a particular viewer from the personalized data database 520 in the data storage facility 505. Upon retrieving this personalized data, the personalized advertisement service module 605 accesses the advertisement images stored in storage medium 515 and selects one of the advertisement images based on the retrieved personalized data. In one exemplary embodiment, each of the plurality of advertisement images stored in storage medium 515 has a plurality of attributes. These attributes generally represent demographics of viewers most suited for viewing the advertisement. In one example, an advertisement image of beer includes the attributes sex: male, age: greater than 21, recreational interest: sports. Another advertisement image of a wine cooler, includes the attributes sex: female, age: greater than 21. An advertisement image of a carbonated beverage includes a wide variety of attributes. The personalized advertisement service module 605 compares the personalized data retrieved from database 520 with the attributes associated with the various advertisement images. The personalized advertisement service module 605 then determines the advertisement image that has attributes consistent with the personalized data. Generally, the advertisement image most consistent with the personalized data is selected by the personalized advertisement service module 605. The advertisement imposing service module 610 retrieves the selected advertisement image from personalized advertisement service module 605 and the region information from region determination service 615 and imposes the selected advertisement image as described above, resulting in a processed motion picture. The advertisement imposing service module 610 provides the processed motion picture to a media transport service module 625 which delivers the processed motion picture to the particular viewer associated with the personalized data and with client 535. The media transport service module 625 formats the processed motion picture as a video signal in a suitable form for transmission over the data network 530 and receipt by the client 535.

FIG. 7 shows several views of the advertisement images storage medium 515, in accordance with an exemplary embodiment of the present invention. In this embodiment, advertisement images stored within the storage medium 515 are arranged in a generally hierarchical fashion. At one level 710, the advertisement images are grouped into a plurality of files based on the subject matter or based on the type of advertisement. This level 710 includes automobile file 715, clothing file 720, banner file 725, beverage bottle file 730, and shoes file 735. Other files are incorporated in various embodiments depending on the particular advertisement images available, as will be appreciated by those skilled in the art. At a second lower level 740, each of the files 715-735 in first level 710 opens to reveal particular advertisement images within that file. For example, second level 740 corresponds to file 730 in first level 710. Within beverage bottle file 730, there are a plurality of advertisement images showing beverage bottles, including, for example: an image of brand A cola 745, an image of brand B cola 750, and an image of beer X 755. The image files may be in any suitable format such as JPEG or GIF. The images 745 to 755 show images of the particular cola or beer. In this exemplary embodiment, the files 715-735 in first level 710 each include a plurality of attributes associated with that file. In this way, a file is selected by personalized advertisement service module 605 within server 525 based on how closely the attributes with the particular file correspond to the personalized data associated with the particular viewer. A further step in the selection process then includes opening that selected file, in one example, beverage bottle file 730, and similarly performing a matching operation on the images within that file. In this example, brand A cola 745, brand B cola 750 and beer X 755 each have a unique set of attributes. Thus, the personalized data for a particular viewer is compared with the attributes of each image, and the image having the most consistent attributes is then selected for delivery to the viewer.

In other exemplary embodiments, the advertisement images may be arranged within storage medium 515 in other fashions generally known to those skilled in the art.

In another embodiment of this invention, instead of embedding the advertising image on the fly, this could be done in advanced. For example, in an Episode of “Will & Grace”, Will may have filmed the original scene with him pouring a bowl of cereal of “Raisin Bran.” A new version of this segment can be made where he appears to be pouring a bowl of “Cheerios”, “Wheaties”, “Count Chocula”, etc. The editors could make 50 different version of the same scene, with each one showing different types of cereal.

After those 50 different versions have been produced, they can be individually delivered to particular viewers, based on the desires of the particular advertiser.

In a final example, there may be three different versions of the new James Bond movie. In the three versions that have been digitally remastered, James Bond appears to be wearing one of three different watches: a Timex, a Rolex, and a Casio. There are three distinct types of people who wish to see this James Bond movie at home: Person A, B, and C. When person A is watching this movie at home, he will see the Timex watch on James. Person B will see the Rolex, and person C will see the Casio watch. The three different watch advertisers were able to target these versions of the James Bond movie to exactly the type of person they wanted.

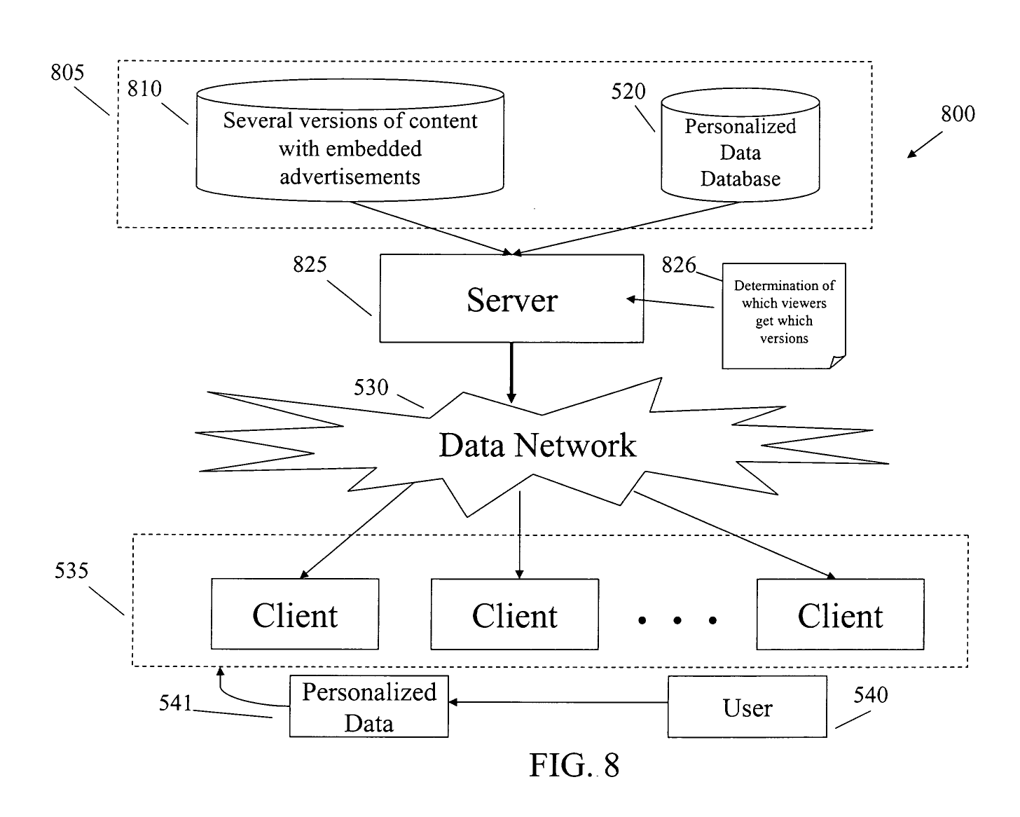

FIG. 8 shows a system 800 for delivering a motion picture having a personalized advertisement embedded in the motion picture to a viewer constructed to an exemplary embodiment of the present invention. The system of FIG. 8 is similar to the system of FIG. 5 in some respects. The system of FIG. 8, however, includes a server 825 which communicates with a data storage facility 805 to provide a different functionality than the corresponding components in the system of FIG. 5. In FIG. 8, motion picture content is stored as a video signal in a storage medium 810. A plurality of versions of the motion picture are stored in storage medium 810. Each version of the motion picture includes a unique embedded advertisement in the motion picture using techniques described above. Personalized data from personalized data database 520 is similarly retrieved by the server 825 so the appropriate version of the motion picture can be retrieved by server 825 from storage medium 810 for delivery to a viewer associated with the personalized data. In this embodiment, however, the sequence of image frames comprising the edited motion picture are retrieved by the server, as opposed to only the particular advertisement image. Information 826, for example, in the form of a table in which particular viewers are identified as having particular versions of the motion picture, is provided to the server 825.

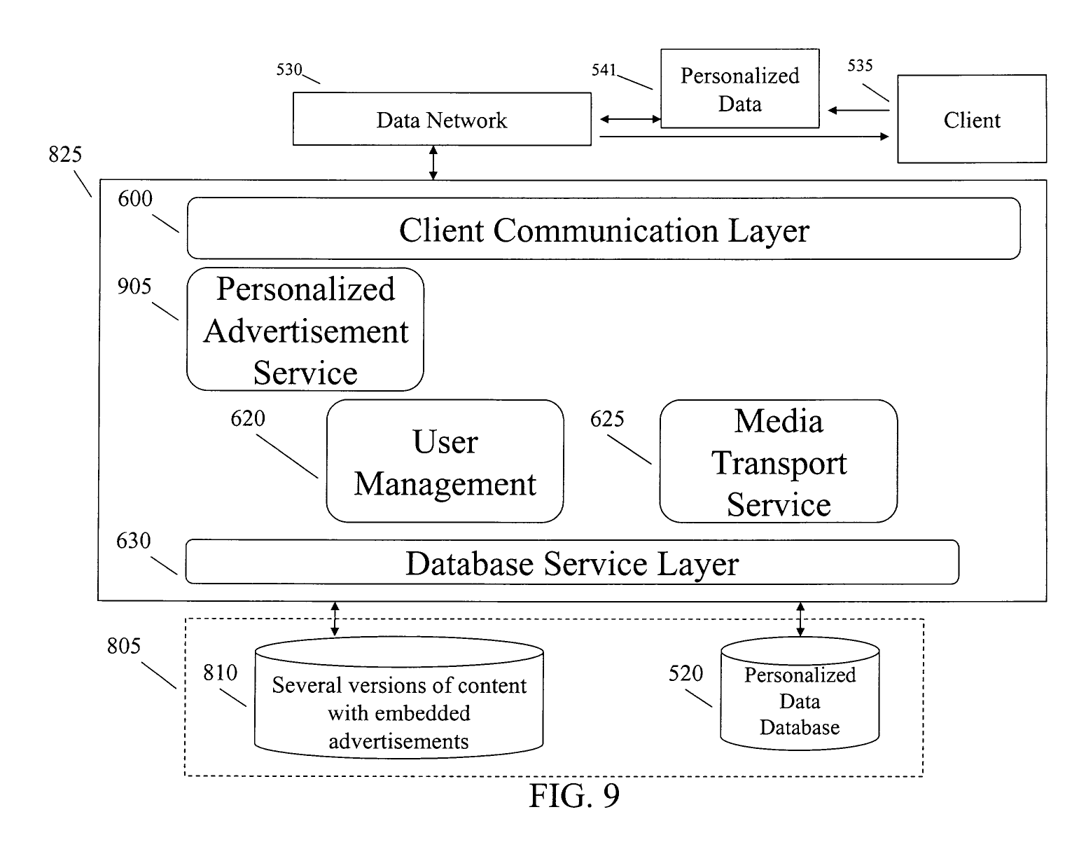

FIG. 9 shows a block diagram of server 825 of FIG. 8 constructed according to an exemplary embodiment of the present invention. The server 825 includes some layers and modules similar to server 525 of FIG. 6. However, a personalized advertisement service module 905 within server 825 provides different functionality than its counterpart in server 525 of FIG. 6. In particular, personalized advertisement service module 905 retrieves from storage medium 810 a particular version of the motion picture having an appropriate embedded advertisement based on personalized data retrieved from database 520. The selection of the particular version of the motion picture is based on comparing the personalized data of a particular viewer with attributes associated with that version of the motion picture. This is to be contrasted with the comparison of the personalized data with attributes associated with advertisement images in FIG. 6. In this embodiment, each motion picture has associated attributes for comparison. Using techniques described above, the most appropriate version of the motion picture is then selected by the personal advertisement service module 905 for delivery to the viewer. The motion picture is then delivered to the client 535 for viewing by the viewer through data network 530 by the media transport service module 625.

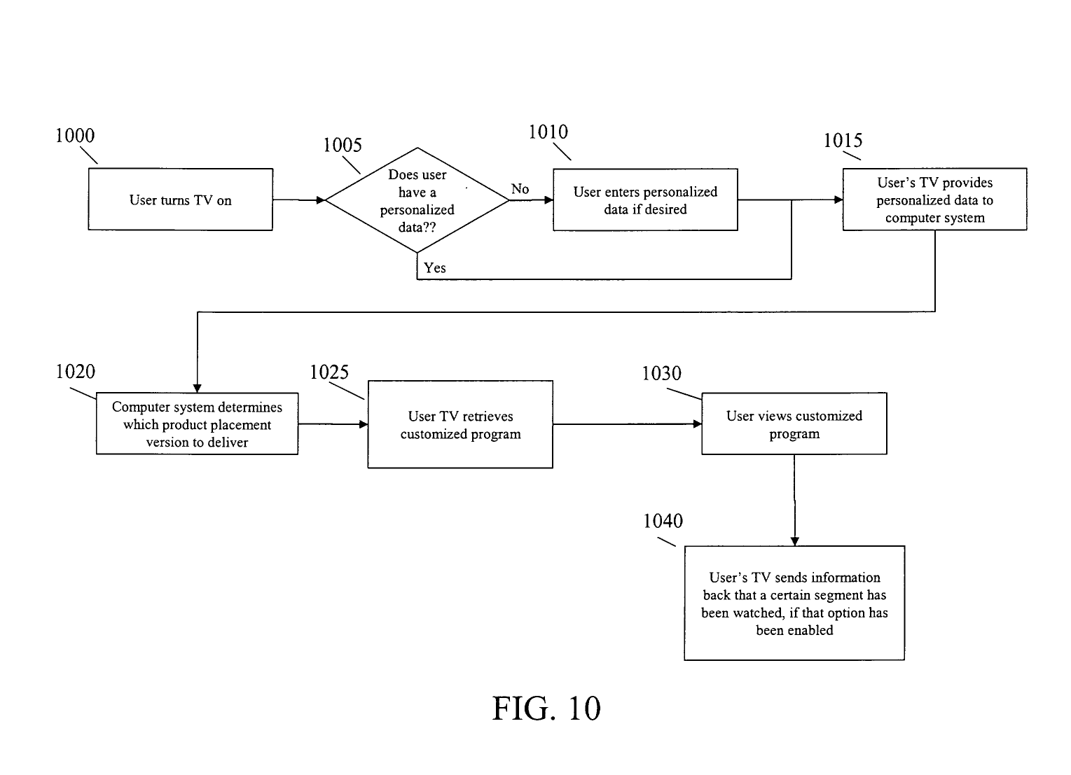

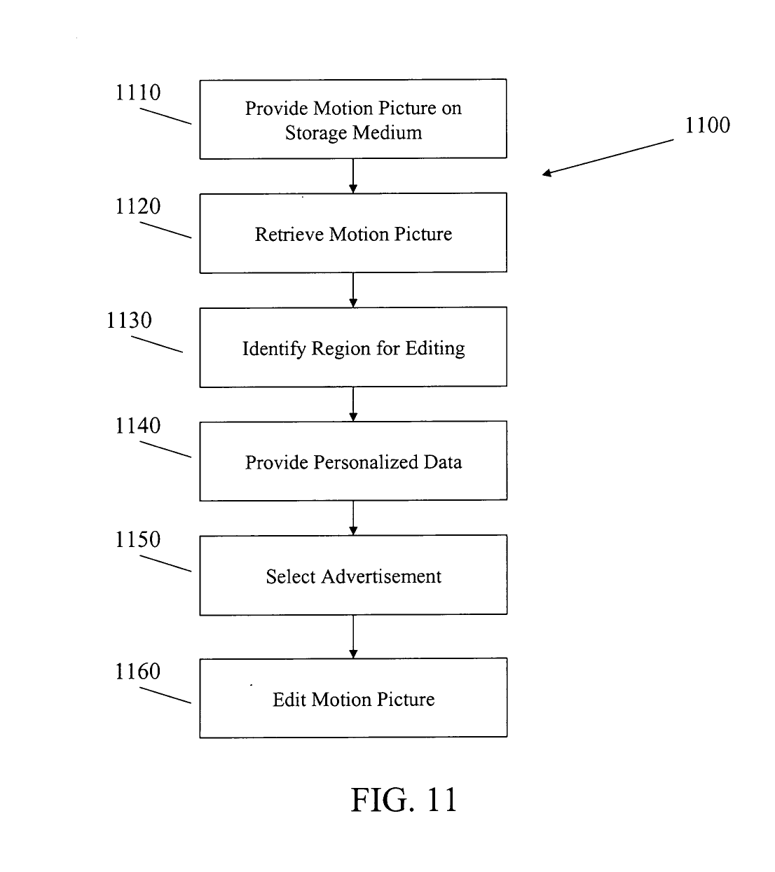

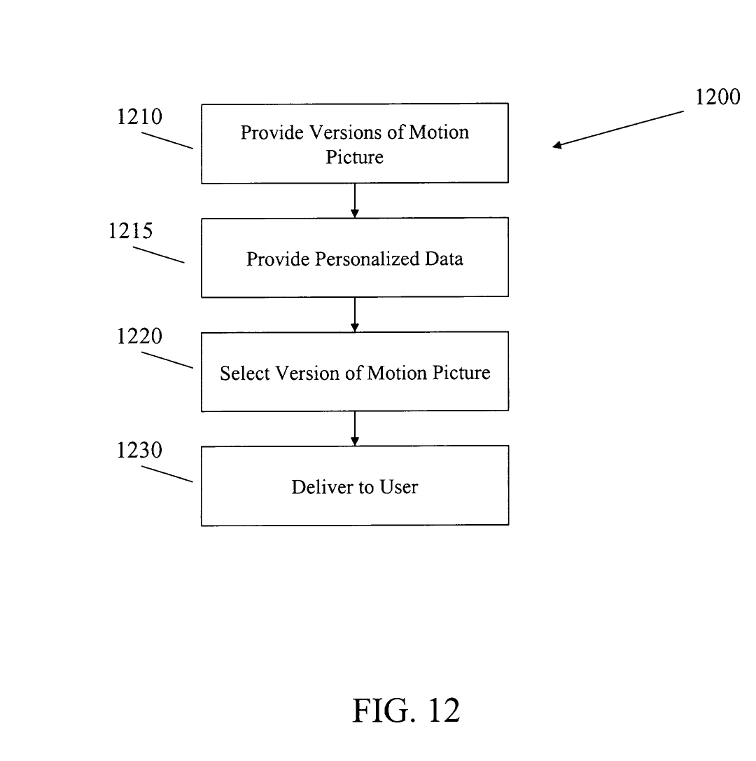

FIG. 10 shows a method of delivering a motion picture having a personalized advertisement to a user, performed in accordance with an exemplary embodiment of the present invention. In step 1000, the user turns on a display device such as a television. In step 1005, if the user has provided personalized data to server 525 or 825, flow proceeds to step 1015. Personalized data has preferably been input by the user into a computer system or other data processing apparatus such as a television set top box and sent over the data network 530 to the server 525. If this has not been done, the user can enter such personalized data in step 1010. In step 1015, the user's personalized data is sent to server 525 or 825. The personalized data can then be stored in the personalized data database 520. In step 1020, the server determines which particular advertisement image or version of a motion picture to deliver to the viewer, depending on the embodiment. This determination step 1020 is described for the different embodiments in greater detail below in FIGS. 11 and 12. In step 1025, the user receives the motion picture with the personalized advertisement for viewing in step 1030 on the display device. The customized program is sent to the client 535 associated with the viewer over the data network 530. In some embodiments, in step 1040, the client or display device operated by the viewer sends a signal back to the server 525 over the data network 530 after the motion picture has been displayed on the display device.

FIG. 11 shows an exemplary method 1100 of embedding a personalized advertisement into a motion picture for delivery to a viewer, performed in accordance with an exemplary embodiment of the present invention. The method of FIG. 11 is described with reference to FIGS. 5, 6 and 7. In step 1110, a motion picture is provided. The motion picture is generally stored on content media storage medium 510 of FIG. 5 with other motion pictures. The motion picture is generally provided as a video signal having a sequence of image frames. The video signal is in any suitable format for storage and later retrieval and display on a display device in an acceptable format as will be understood by those skilled in the art such as MPEG. The motion picture may be a movie, television program, or other suitable video content.

In step 1120, the motion picture is retrieved from the content media storage medium 510 by the server 525. The motion picture is retrieved as a video signal from the storage medium and provided to the advertisement imposing service module 610 within server 525. In step 1130, the region determination service module 615 identifies from the retrieved video signal a region within each of the image frames in a sequence within that motion picture. In step 1140, the personalize data associated with a particular viewer is retrieved by the personalized advertisement service module 605 from the database 520. In an alternative embodiment, the personalized advertisement service module 605 receives the personalized data associated with a particular viewer over the data network 530 from the client 535 associated with that viewer.

In step 1150, the personalized advertisement service module 605 selects one of a plurality of advertisement images stored in storage medium 515. This selection is based on the personalized data associated with the particular viewer. As described above, in one embodiment, the selection is made by comparing the personalized data with the attributes associated with the respective advertisement images stored in storage medium 515. The advertisement image having attributes most compatible with the personalized data provided by the user is determined and selected.

In step 1160, the retrieved motion picture is edited. That is, the selected advertisement image selected at step 1150 is imposed on the identified region from step 1130 within each of the image frames in the sequence comprising the motion picture. In some examples, in one or more of the image frames in the sequence, the selected advertisement image is scaled as desired for imposition on the identified region.

After the motion picture is edited, the motion picture can be delivered by media transport service module 625 to the client 535 over the data network 530 as a video signal. In an alternative embodiment, the edited motion picture is stored on any storage medium in communication with the server 525 for later retrieval by or delivery to the viewer.

FIG. 12 shows a method 1200 of delivering a motion picture having a personalized advertisement to a viewer performed in accordance with an exemplary embodiment of the present invention. The method of FIG. 12 is described with reference to FIGS. 8 and 9. In step 1210, a plurality of versions of a motion picture are provided. These versions of the motion picture include the same sequence of image frames, although in each respective version, a different advertisement image is imposed on the sequence of image frames. The versions of the motion picture are stored on storage medium 810 in data storage facility 805 of FIG. 8. When a user 540 connects to the server 825 via one of the clients 535 in FIG. 8, the server identifies the user based on information submitted by the user. For example, this may be a serial number or other ID number associated with a set top box or computer with a display device that is operated by the use. The server, in step 1215, can then retrieve personalized data from the database 520 for that particular user. In an alternative embodiment, the personalized data is submitted to the server 825 over data network 530 from the client 535. In step 1220, using the personalized data, the personalized advertisement service module 905 within server 825 selects the version of the motion picture most consistent with the personalized data. This is done generally by comparing the personalized data with attributes associated with each of the versions of the motion picture stored in the storage medium 810, as described in greater detail above. After the particular version of the motion picture is selected, in step 1230, the media transport service module 625 delivers the selected motion picture version to the client 535 over the data network 530 as a video signal, also described above with respect to FIG. 11.

FIG. 13 shows a general purpose computer system 1300 constructed in accordance with an exemplary embodiment of the present invention. The general purpose computer, in an exemplary embodiment, acts as the server and/or client of FIGS. 5, 6, 8, and 9. The general purpose computer 1300 of FIG. 13 includes a processor 1330 and memory 1325. Processor 1330 may contain a single microprocessor, or may contain a plurality of microprocessors, for configuring the computer system as a multi-processor system. In embodiments described above, the processor 1330 includes the server processor and client processor of FIGS. 5, 6, 8, and 9. Memory 1325, stores, in part, instruction and data for execution by processor 1330. If the system of the present invention is wholly or partially implemented in software, including computer instructions, memory 1325 stores the executable code when in operation. Memory 1325 may include banks of dynamic random access memory (DRAM) as well as high speed cache memory.

The computer of FIG. 13 further includes a mass storage device 1335, peripheral device(s) 1340, input device(s) 1355, portable storage medium drive(s) 1360, a graphics subsystem 1370 and a display means 1385. For purposes of simplicity, the components shown in FIG. 13 are depicted as being connected via a single bus 1380 (i.e. transmitting means). However, the components may be connected through one or more data transport means (e.g. Internet, Intranet, etc.). For example, processor 1330 and memory 1325 may be connected via a local microprocessor bus, and the mass storage device 1335, peripheral device(s) 1340, portable storage medium drive(s) 1360, and graphics subsystem 1370 may be connected via one or more input/output (I/O) buses. Mass storage device 1335, which is typically implemented with a magnetic disk drive or an optical disk drive is, in one embodiment, a non-volatile storage device for storing data and instructions for use by processor 1330. The mass storage device 1335 includes the storage medium of embodiments of the present invention, and the server storage medium and client storage medium in alternative embodiments. The computer instructions that implement the methods of the present invention also may be stored in processor 1330.

Portable storage medium drive 1360 operates in conjunction with a portable non-volatile storage medium, such as a floppy disk, or other computer-readable medium, to input and output data and code to and from the computer system of FIG. 13. In one embodiment, the method of the present invention that is implemented using computer instructions is stored on such a portable medium, and is input to the computer system 1300 via the portable storage medium drive 1360. Peripheral device(s) 1340 may include any type of computer support device, such as an input/output (I/O) interface, to add additional functionality to the computer system 1300. For example, peripheral device(s) 1340 may include a network interface card for interfacing computer system 1300 to a network, a modem, and the like.

Input device(s) 1355 provide a portion of a user interface. Input device(s) 1355 may include an alpha-numeric keypad for inputting alpha-numeric and other key information, or a pointing device, such as a mouse, a trackball, stylus or cursor direction keys. In order to display textual and graphical information, the computer 1300 of FIG. 13 includes graphics subsystem 1370 and display means 1385. Display means 1385 may include a cathode ray tube (CRT) display, liquid crystal display (LCD), other suitable display devices, or means for displaying, that enables a user to view the customized program. Graphics subsystem 1370 receives textual and graphical information and processes the information for output to display 1385. The display means 1385 provides a practical application for providing the customized program of the present invention since the method of the present invention may be directly and practically implemented through the use of the display means 1385. Additionally, the computer of FIG. 13 includes output devices 1345. Examples of suitable output devices include speakers, printers, and the like.

The devices contained in the computer system of FIG. 13 are those typically found in general purpose computers, and are intended to represent a broad category of such computer components that are well known in the art. The system of FIG. 13 illustrates one platform which can be used for practically implementing the method of the present invention. Numerous other platforms can also suffice, such as Macintosh-based platforms available from Apple Computer, Inc., platforms with different bus configurations, networked platforms, multi-processor platforms, other personal computers, workstations, mainframes, navigation systems, and the like.

In a further embodiment, the present invention also includes a computer program product which is a computer readable medium (media) having computer instructions stored thereon/in which can be used to program a computer to perform the methods of the present invention as described herein above. The computer readable medium can include, but is not limited to, any type of disk including floppy disks, optical disks, DVD, CD ROMs, magnetic optical disks, or other types of medium including RAM, EPROM, EEPROM, magnetic or optical cards, or any type of media suitable for storing electronic instructions.

These same computer instructions may be located in an electronic signal that is transmitted over a data network that performs the methods as described herein above when loaded into a computer. The computer instructions are in the form of data being transmitted over a data network. In one embodiment, the method of the present invention is implemented in computer instructions and those computer instructions are transmitted in an electronic signal through cable, satellite or other transmitting means for transmitting the computer instructions in the electronic signals.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems and user applications. Ultimately, such computer readable media further includes software for performing the methods of the present invention as described above.

There are several advantages to the exemplary embodiments discussed above. The first advantage is the targeting of advertisements to specific individuals. Individuals will see advertisements for products and services they are more likely to be interested in. These personalized advertisements will keep the individual viewer better entertained and more informed on items and services of interest. From the viewpoint of the advertiser, they can now target to a very specific demographic group, all the way down to the specific individual. The current invention provides the advertiser with an extremely powerful and effective advertising strategy. The broadcaster and content providers can now realize higher profits through targeted advertising.

Since the current invention targets advertisements to individuals by embedding the advertisement into the program, there is no need to interrupt the viewing of the program. In addition, embedding the advertisement makes it impossible for the viewer to skip the advertisements as they might today using a PVR. Broadcasters and content providers can continue to realize profits on their assets, even as consumers are empowered with high tech devices such as PVRs. With the ability to target advertisements and place many more advertisements, as product placement is less disruptive, the broadcaster and content provider could realize even higher profits than they do with conventional advertising.

What is claimed is:

1. A method for providing intelligent advertisement placement in a motion picture, comprising:
retrieving personalized data associated with a viewer;
comparing the personalized data with a plurality of attributes, each attribute associated with an advertisement image, to determine an attribute that is most consistent with the personalized data;
retrieving an advertisement image associated with the attribute that is most consistent with the personalized data; and
imposing the retrieved advertisement image on a sequence of image frames of a motion picture.

2. A method as recited in claim 1, further including the step of identifying one or more regions within each of a sequence of image frames of a motion picture and wherein the step of imposing the retrieved advertisement image on a sequence of image frames of a motion picture includes imposing the retrieved advertisement image in the one or more regions within each of the sequence of image frames of the motion picture.

3. A method as recited in claim 1, wherein the step of retrieving personalized data associated with a viewer includes retrieving personalized data associated with a viewer from a client computer over a data network.

4. A method as recited in claim 1, wherein the step of imposing the retrieved advertisement image on a sequence of image frames of a motion picture includes imposing the retrieved advertisement image on a sequence of image frames of a motion picture selected by the viewer.

5. A method as recited in claim 1, further including the steps of generating attributes based on demographic information and associating the attributes with advertisement images.

6. A method as recited in claim 5, wherein the step of generating attributes based on demographic information further includes generating attributes based on demographic information selected from a group including age, gender, income, occupation, recreational interest, and geographic information.

7. A method as recited in claim 5, wherein the step of associating the attributes with advertisement images includes associating the attributes with advertisement images selected from a group including banners and graphical objects.

8. A method as recited in claim 1, further including the step of scaling the retrieved advertisement image and wherein the step of imposing the retrieved advertisement image on a sequence of image frames of a motion picture includes imposing the scaled advertisement image on a sequence of image frames of a motion picture.

9. A method as recited in claim 8, wherein the step of scaling the retrieved advertisement image includes scaling the retrieved advertisement image to several different scales so that after the scaled advertisement image is imposed on the sequence of image frames, the scaled image appears to move one of toward and away from a viewer when viewing the motion picture.

10. A method as recited in claim 1, further including the step of transmitting the motion picture, including the retrieved advertisement image imposed therein, to a client computer over a data network.

11. A method as recited in claim 1, further including the step of storing the motion picture, including the retrieved advertisement image imposed therein, on a storage medium.

12. A method for providing intelligent advertisement placement in a motion picture, comprising:
storing two or more versions of a motion picture on a storage medium, each version of the motion picture having a different advertisement image imposed on a sequence of image frames;
retrieving personalized data associated with a viewer;
comparing the personalized data with attributes, each attribute associated with a version of the motion picture, to determine an attribute that is most consistent with the personalized data; and
retrieving a version of the motion picture that is associated with the attribute that is most consistent with the personalized data.

13. A method as recited in claim 12, further including the steps of imposing a first advertisement image on a sequence of image frames of a first version of the two or more versions of the motion picture and imposing a second advertisement image on the sequence of image frames of a second version of the two or more versions of the motion picture.

14. A method as recited in claim 13, further including the steps of scaling the first advertisement image and scaling the second advertisement image prior to imposing the first advertisement image and second advertisement image on the respective sequence of image frames.

15. A method as recited in claim 12, wherein the step of retrieving personalized data associated with a viewer includes retrieving personalized data associated with a viewer from a client computer over a data network.

16. A method as recited in claim 12, further including the steps of generating attributes based on demographic information and associating each attribute with a version of the motion picture.

17. A method as recited in claim 16, wherein the step of generating attributes based on demographic information further includes generating attributes based on demographic information selected from a group including age, gender, income, occupation, recreational interest, and geographic information.

18. A method as recited in claim 12, further including the step of transmitting the version of the motion picture associated with the attribute that is most consistent with the personalized data to a client computer over a data network.

19. A computer system for providing intelligent advertisement placement in a motion picture, comprising:
a storage medium for storing personalized data, attributes, advertisement images, and motion pictures; and
a processor in communication with the storage medium, wherein the processor is operative to
a) retrieve personalized data associated with a viewer;
b) compare the personalized data with attributes, each attribute associated with an advertisement image, to determine an attribute that is most consistent with the personalized data;
c) retrieve an advertisement image associated with the attribute that is most consistent with the personalized data; and
d) impose the retrieved advertisement image on a sequence of image frames of a motion picture.

20. A computer system as recited in claim 19, further including the operative step to identify one or more regions within each of a sequence of image frames of a motion picture and wherein the operative step to impose the retrieved advertisement image on a sequence of image frames of a motion picture includes the operative step to impose the retrieved advertisement image in the one or more regions within each of the sequence of image frames of the motion picture.

21. A computer system as recited in claim 19, wherein the operative step to retrieve personalized data associated with a viewer includes the operative step to retrieve personalized data associated with a viewer from a client computer over a data network.

22. A computer system as recited in claim 19, wherein the operative step to impose the retrieved advertisement image on a sequence of image frames of a motion picture includes the operative step to impose the retrieved advertisement image on a sequence of image frames of a motion picture selected by the viewer.

23. A computer system as recited in claim 19, further including the operative steps to generate attributes based on demographic information and associate the attributes with advertisement images.

24. A computer system as recited in claim 19, further including the operative step to scale the retrieved advertisement image and wherein the operative step to impose the retrieved advertisement image on a sequence of image frames of a motion picture includes the operative step to impose the scaled advertisement image on a sequence of image frames of a motion picture.

25. A computer system as recited in claim 24, wherein the operative step to scale the retrieved advertisement image includes the operative step to scale the retrieved advertisement image to several different scales so that after the scaled advertisement image is imposed on the sequence of image frames, the scaled image appears to move one of toward and away from a viewer when viewing the motion picture.

26. A computer system as recited in claim 19, further including the operative step to transmit the motion picture to a client computer over a data network.

27. A computer system as recited in claim 19, further including the operative step to store the motion picture on a storage medium.

28. A computer system for providing intelligent advertisement placement in a motion picture, comprising:
a storage medium for storing personalized data, attributes, advertisement images, and motion pictures; and
a processor in communication with the storage medium, wherein the processor is operative to
a) store two or more versions of a motion picture on a storage medium, each version of the motion picture having a respective advertisement image imposed on a sequence of image frames;
b) retrieve personalized data associated with a viewer;
c) compare the personalized data with attributes, each attribute associated with a version of the motion picture, to determine an attribute that is most consistent with the personalized data; and
d) retrieve a version of the motion picture that is associated with the attribute that is most consistent with the personalized data.

29. A computer system as recited in claim 28, further including the operative steps to impose a first advertisement image on a sequence of image frames of a first version of the two or more versions of the motion picture and impose a second advertisement image on the sequence of image frames of a second version of the two or more versions of the motion picture.

30. A computer system as recited in claim 29, further including the operative steps to scale the first advertisement image prior to imposing the first advertisement image on the sequence of image frames of the first version of the two or more versions of the motion picture and scale the second advertisement image prior to imposing the second advertisement image on the sequence of image frames of the second version of the two or more versions of the motion picture.

31. A computer system as recited in claim 28, wherein the operative step to retrieve personalized data associated with a viewer includes the operative step to retrieve personalized data associated with a viewer from a client computer over a data network.

32. A computer system as recited in claim 28, further including the operative steps to generate attributes based on demographic information and associate each attribute with a version of the motion picture.

33. A computer system for providing intelligent advertisement placement in a motion picture, comprising:
means for retrieving personalized data associated with a viewer;
means for comparing the personalized data with a plurality of attributes, each attribute associated with an advertisement image, to determine an attribute that is most consistent with the personalized data;
means for retrieving an advertisement image associated with the attribute that is most consistent with the personalized data; and
means for imposing the retrieved advertisement image on a sequence of image frames of a motion picture.

34. A computer system for providing intelligent advertisement placement in a motion picture, comprising:
means for storing two or more versions of a motion picture of a storage medium, each version of the motion picture having a different advertisement image imposed on a sequence of image frames;
means for retrieving personalized data associated with a viewer;
means for comparing the personalized data with attributes, each attribute associated with a version of the motion picture, to determine an attribute that is most consistent with the personalized data; and
means for retrieving a version of the motion picture that is associated with the attribute that is most consistent with the personalized data.
